(19) United States
(12) Patent Application Publication
(10) Pub. No.: US 2015/0134273 A1
(43) Pub. Date: May 14, 2015

(54) VISUALIZATION OF REFERENCES DURING INDUCTION THERMOGRAPHY

(71) Applicants: Lukasz Adam Bienkowski, Munchen (DE); Christian Homma, Kirchheim b. Munchen (DE); Max Rothenfusser, Munchen (DE)

(72) Inventors: Lukasz Adam Bienkowski, Munchen (DE); Christian Homma, Kirchheim b. Munchen (DE); Max Rothenfusser, Munchen (DE)

(73) Assignee: SIEMENS AKTIENGESELLSCHAFT, München (DE)

(21) Appl. No.: 14/401,472

(22) PCT Filed: Jun. 12, 2013
(86) PCT No.: PCT/EP2013/062098

§ 371 Date: Nov. 14, 2014

(30) Foreign Application Priority Data
Jul. 16, 2012 (DE) 10 2012 212 434.9

(51) Int. Cl. G01N 25/72; G01N 21/88

(52) U.S. Cl. CPC G01N 25/72; G01N 21/8851; G01N 2201/12
USPC 702/38

(57) ABSTRACT

Non-destructive material examination of a test part by scanning induction thermography improves upon the quality of a manual measurement by an inspecting person. Recorded infrared images undergo evaluation and references corresponding to the evaluation are projected onto the test piece for an inspecting person.

### CROSS REFERENCE TO RELATED APPLICATIONS

This application is the U.S. national stage of International Application No. PCT/EP2013/062098, filed Jun. 12, 2013 and claims the benefit thereof. The International Application claims the benefit of German Application No. 102012212434.9 filed on Jul. 16, 2012, both applications are incorporated by reference herein in their entirety.

### BACKGROUND

Described below are a method and a device for induction thermography for nondestructive material examination.

During an examination by induction thermography, a test head, which is also denoted as an inductor, is positioned over a test object or over a test specimen. The magnetic field resulting from the current flowing in the test head generates an electric induction current in the test specimen to be examined. The induction current leads to a heating of the test specimen by ohmic losses. The heat distribution resulting in the test specimen can, in turn, be detected by an infrared camera. If the test specimen includes defects, such as cracks, for example, the induced current must flow around them or via existing contact points. The process leads to an increase in a local current density and, following therefrom, a heating at the points. Cracks can therefore be detected in the infrared image. The method and device described below for induction thermography of a test specimen by which material defects are detected with a maximum defect detection probability in the case of nonautomated measuring processes. The aim is to be able to find all material defects of a specific type, starting from a defined and specific size, reproducibly in the entire test specimen or in a specific region of the test specimen.

The aim is to ensure that the defect detection probability is maximized. The aim is to use an examination of a test specimen to be able to find all defects of a specific type, such as cracks, for example, starting from a defined and specific size, reproducibly in the entire test specimen or in a specific region of the test specimen.

Here, defect detection probability is defined as a statement represented as a probability curve used to describe probabilities of the acquisition of material defects as a function of the size of the material defect, and of all relevant measurement parameters. The measurement parameters can be known and/or be set directly or indirectly. Measurement parameters are, in particular, the distance between inductor and test specimen, size of the induction region in the test specimen, and direction of the induction current flow.

Use is made of so-called defect detection probability curves (probability of detection/POD curves) which represent the probability of detection as a function of the defect size and taking account of all the important measurement parameters. The measurement parameters are either known or can be influenced directly or indirectly. It is therefore possible to make a statement concerning the minimum size a defect must have in order to be detected with sufficient accuracy. However, the statement is only correct when all the restrictions of a measurement are taken into account. If, for example, the inductor is held too far away from the test specimen by the testing technician, the measurement parameters are changed and the statement loses its validity.

In accordance with a first aspect, a method for scanning induction thermography is proposed for nondestructive material examination of a test specimen, the test specimen and an inductor which has an infrared camera, which records infrared images, and generates an electric induction current in the test specimen being positioned relative to one another by a testing technician during a manual measurement. An evaluation, carried out by a computer device, of at least one of the recorded infrared images, and a projection, performed by a projector device onto the surface of the test specimen, of in each case one indication for the testing technician which corresponds to a result of the evaluation are performed.

In accordance with a second aspect, a device for scanning induction thermography for nondestructive material examination of a test specimen is proposed, the test specimen and an inductor which has an infrared camera, which records infrared images, and generates an electric induction current in the test specimen being positioned relative to one another by a testing technician during a manual measurement, an evaluation, carried out by a computer device, of at least one of the recorded infrared images, and a projection, performed by a projector device onto the surface of the test specimen, of in each case one indication for the testing technician which corresponds to a result of the evaluation being carried out.

Thus, a system is proposed which supports the testing technician during or after a measurement by virtue of the fact that important indications are projected directly onto the test specimen. The aim is to provide the testing condition during or directly after the measurement with feedback which is projected onto the test specimen and indicates to the testing technician whether the measurement is or has been carried out correctly with respect, in particular, to the defect detection probability. It has been recognized that the measurement result of a manual, nonautomated induction thermography depends very strongly on the testing technician with regard to the acquisition of material defects and likewise with regard to the defect detection probability (so-called human aspect). According to the invention, information from infrared images is used to evaluate material defects and to estimate the defect detection probability, in order to support the testing technician during or after the measurement and to reduce as far as possible the influence of the so-called human aspect.

In accordance with an advantageous refinement, an indication during or after the measurement can indicate whether the measurement is or has been carried out correctly in respect of a required defect detection probability, taking account of measurement parameters. It has been recognized that the following effect, specifically the distance between the inductor and the test specimen, can influence the defect detection probability. A further measurement parameter results from the fact that the induced current typically flows in the vicinity of the inductor or of the test head such that defects can be detected only in a specific region around the inductor. The region can be designated as measurement region. Should the entire test specimen or a relatively large region be examined, the measurement must be repeated several times with appropriate displacement of the test head. A further important finding is that because of the direction of the current flow it is defects which are situated perpendicular to the current flow or to the inductor which can best be detected. According to the invention, it has been recognized that given nonautomated measurement processes the measurement parameters can lead to limitations such that the measurement becomes defective and the defect detection probability is too low. By projection of the respective defect detection probability onto the testing technician, the defect detection probability can be kept constant during measurement over the entire test specimen or a plurality of test specimens. This is a great advantage in the case of measurements for which it would either be impossible or not profitable to automate.

In accordance with a further advantageous refinement, the computer device can determine the maximum possible defect detection probability of the measurement by defect detection probability curves depending on the magnitude, which is to be acquired, of a material defect while taking account of the measurement parameters, that is to say the characteristics under which the measurement is performed.

In accordance with a further advantageous refinement, the computer device can carry out the evaluation of at least one of the recorded infrared images in order to calculate the measurement parameters of the measurement.

In accordance with a further advantageous refinement, the evaluation of the infrared image of the test specimen can be carried out without an inductor in order to calculate measurement parameters.

In accordance with a further advantageous refinement, in order to calculate measurement parameters the evaluation of an infrared image, recorded before the induction of the induction current, of the positioned inductor and of the test specimen can be carried out.

In accordance with a further advantageous refinement, in order to calculate measurement parameters the evaluation of an amplitude image generated by pulse-phase analysis of the infrared images recorded during the measurement can be carried out.

In accordance with a further advantageous refinement, in order to calculate measurement parameters the evaluation of a phase image generated by pulse-phase analysis of the infrared images recorded during the measurement can be carried out.

In accordance with a further advantageous refinement, the measurement parameters can be the distance between inductor and test specimen, the measurement range of the inductor and/or the orientation of the inductor with respect to the test specimen.

In accordance with a further advantageous refinement, as an indication lines running perpendicular to the orientation of the inductor can be projected onto the test specimen during or after the measurement in order to indicate that material defects extending along the lines are or have been acquired with a maximum possible defect detection probability.

In accordance with a further advantageous refinement, as an indication color-coded areas can be projected onto the test specimen during or after the measurement in order to indicate that material defects extending in specific directions in the respective colored areas are or have been acquired with a maximum defect detection probability.

In accordance with a further advantageous refinement, the orientation of the inductor can be changed after the measurement and a further measurement can be carried out, further lines running perpendicular to the changed orientation of the inductor and further color-coded areas additionally being able to be projected onto the test specimen.

In accordance with a further advantageous refinement, an indication during or after the measurement can be indicated whether the measurement parameters of the measurement are or have been correctly set, given that the geometry of the inductor, the position of the latter with respect to the test specimen, and all the measurement parameters are known.

In accordance with a further advantageous refinement, an indication can indicate the measurement range of the inductor as a colored area on the test specimen as a function of the position of the inductor relative to the test specimen.

In accordance with a further advantageous refinement, an indication can indicate the correctness of the distance between inductor and test specimen during or after the measurement by a specific color of the colored area.

In accordance with a further advantageous refinement, identical measurement ranges of measurements with different orientations of the inductor can be indicated in an overlapping fashion.

In accordance with a further advantageous refinement, an indication can indicate an information item relating to the quality of the positioning of the inductor.

### BRIEF DESCRIPTION OF THE DRAWINGS

These and other aspects and advantages will become more apparent and more readily appreciated from the following description of exemplary embodiments, taken in conjunction with the accompanying drawings of which:

FIG. 1 is a perspective view of a first exemplary embodiment of an indication according to the invention;

FIG. 2 is a perspective view of a second exemplary embodiment of an indication according to the invention;

FIG. 3 is a perspective view of a third exemplary embodiment of an indication according to the invention;

FIG. 4 is a perspective view of a fourth exemplary embodiment of an indication according to the invention;

FIG. 5 is a perspective view of an exemplary embodiment of a further measurement;

FIG. 6 is a perspective view of a fifth exemplary embodiment of an indication according to the invention; and

FIG. 7 is a perspective view of a sixth exemplary embodiment of an indication according to the invention.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

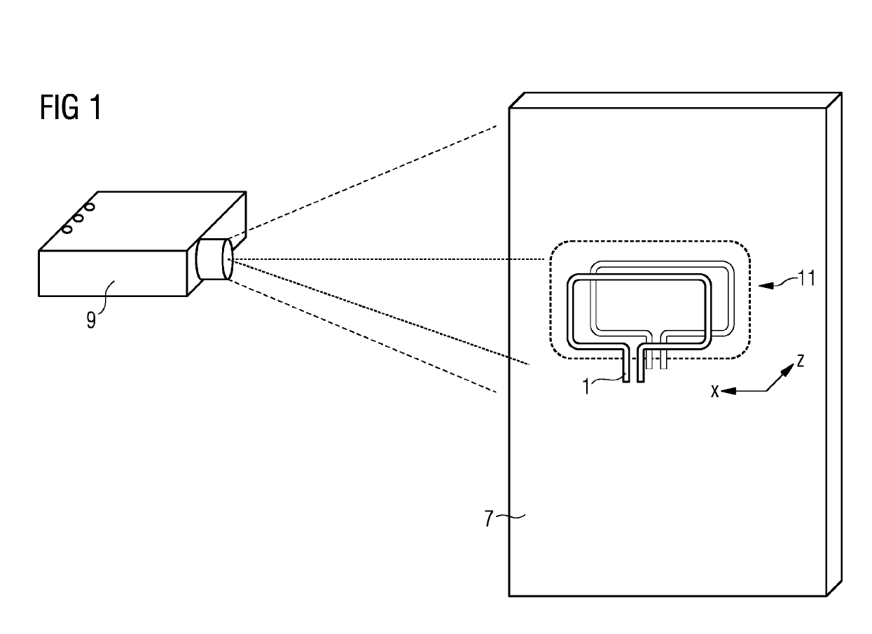

FIG. 1 shows a first exemplary embodiment of an indication according to the invention. FIG. 1 shows a projector device 9 which projects an indication 11, resulting from an evaluation, for the testing technician onto the surface of a test specimen 7 onto the surface of the test specimen 7. An inductor 1 in a position relative to the test specimen 7 is also illustrated.

The indication 11 in accordance with FIG. 1 is a red field which has been projected onto the test specimen 7 underneath the inductor 1. The color red indicates to the testing technician that the inductor 1 is not yet correctly positioned relative to the test specimen 7. The indication 11 includes, in addition, two arrows, specifically one in the x-direction and one in the z-direction, which indicate to the testing technician how the inductor 1 must be moved relative to the test specimen 7 in order to achieve a correct relative position. Before an actual measurement, it is necessary to decide in which region of the test specimen 7 the measurement is intended to be carried out. Since the geometry of the inductor 1 and the position thereof with respect to the test specimen 7, and all the measurement parameters are known, the region around the inductor 1 in which the induction effect comes about can be determined as a function of the position of the inductor 1 relative to the test specimen 7. The position of the inductor 1 with respect to the test object 7 can be determined, for example, with the aid of a position sensor fitted on the inductor 1.

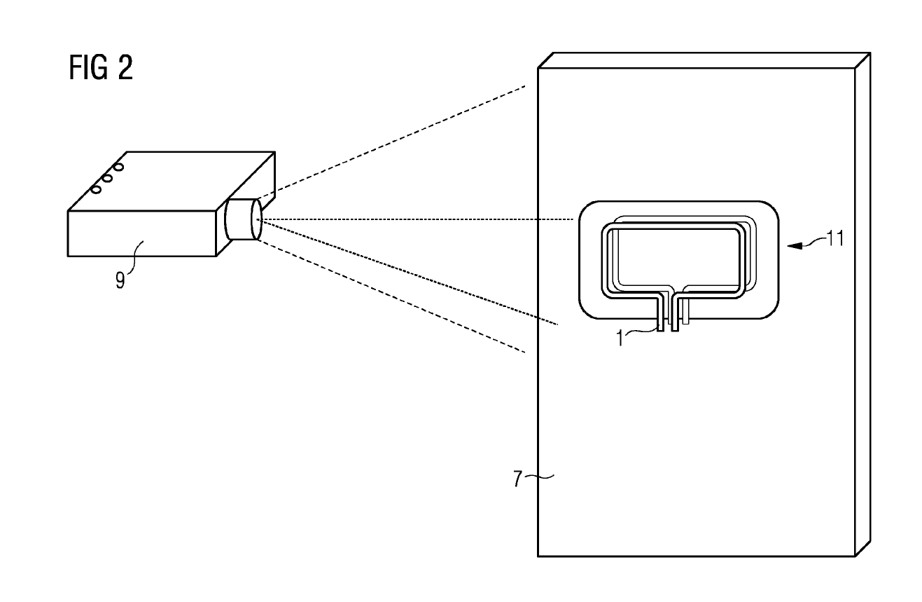

FIG. 2 shows a second exemplary embodiment of an indication according to the invention. In comparison to FIG. 1, the inductor 1 has been moved in the x-direction and z-direction relative to the test specimen 7 by the testing technician in accordance with the stipulations of the arrows. The colored field underneath the inductor 1 now exhibits the color green. The result is an indication 11 in accordance with the second exemplary embodiment. FIG. 2 shows, by way of example, a measurement range in which the induction effect comes about. Before the measurement, the specific range is projected onto the test specimen 7 as a green area, since the distance between the inductor 1 and the test specimen 7 is now correct. The measurement position of the inductor 1 relative to the test specimen 7 has been reached. The measurement can begin.

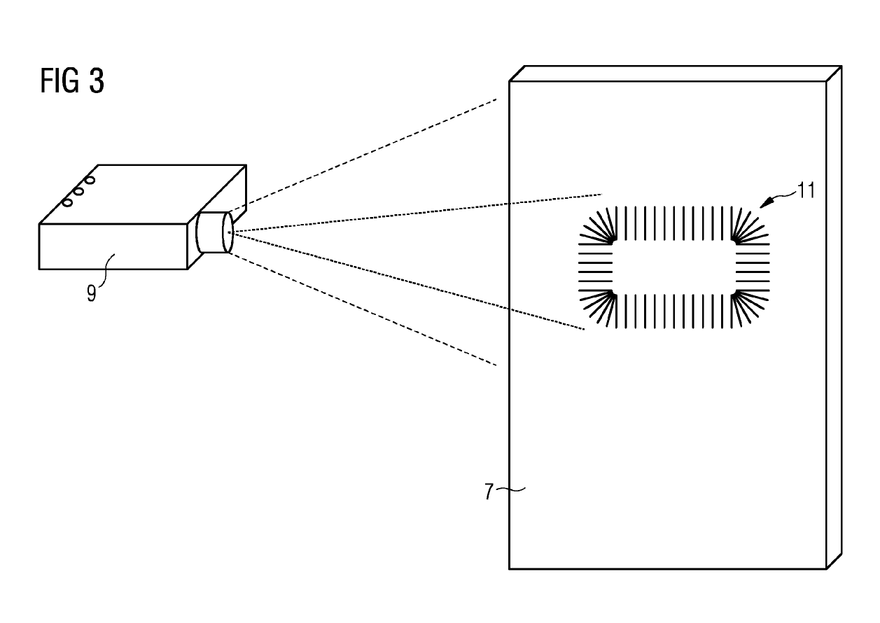

FIG. 3 shows a third exemplary embodiment of an indication 11 according to the invention. The following four images can advantageously be used to create an indication 11. An image of the test specimen 7 without an inductor 1, the image being denoted by “O”. A further image of the positioned inductor 1 and of the test specimen 7 before the current is switched on, the image being denoted by “I”. After the measurement, the recorded infrared image series is subjected to a pulse-phase analysis which constitutes a known algorithm in thermography. The result of this is an amplitude image “A” and a phase image “P”. The following information can be determined therefrom:
1. The x,y-position of the inductor 1 by making use of the images “O” and “I” with the aid of a subtraction

Ix′=(I−O).
2. Region which has been covered by the inductor 1, by making use of the images “O” and “I” in conjunction with the algorithm
3. Region in which the

$${I}^{″} = \{ \begin{matrix}1 & if {I}^{′} > 0 \\ 0 & if {I}^{′} \leq 0\end{matrix} ; t$$

was sufficiently strong, inductors 1 likewise held oblique or at the wrong distance being taken into account by making use of the image “A” by the following:
   1. Masking the inductor

Ax′=A*T′;
2. Converting the amplitude image to form a temperature difference image T;
3. Transforming into a color-coded representation of the defect detection probability For of the contrast/signal-to-noise ratio.
4. Orientation sensitivity by making use of the images “A” and “P”, by the following:
   1. Extracting the lines of the same direction of current flow, the so-called “height lines”;
   2. Calculating the perpendiculars of the height lines, the lines corresponding to the optimum defect orientation, that is to say the direction in which cracks can best be recognized. If, by way of example, a round conductor loop is used as inductor 1, the orientation sensitivity is a halo around the inductor 1.
5. z-position of the inductor 1, specifically the distance inductor 1-test specimen 7, by making use of the image “A” by comparing the amplitude profile in the vicinity of the inductor 1 with the aid of analytically calculated solutions.

It can be judged subsequently whether the defect detection probability in the region under examination is in agreement with the requirement, and the information is projected onto the test specimen 7. It is to be taken into account in this case that the detectability and the defect detection probability depend strongly on the orientation of the test head or of the inductor 1 with respect to potential defects. This must be expressed in the projection. In accordance with FIG. 3, lines of which the orientation is placed perpendicular to the inductor 1 are projected onto the region under examination. In accordance with point number 4 above, the information is determined with regard to the feature of orientation sensitivity. The defect detection probability is highest for defects thus situated. This is illustrated by the indication 11 in accordance with FIG. 3. Use was made of an inductor 1 which is designed in the form of a round conductor loop with the result that the orientation sensitivity is a halo around the inductor 1. Depending on setting, after the measurement green lines oriented perpendicular to the inductor 1 are projected onto the region under examination. The orientation of the defects, and the region in which the latter are detectable can be inferred by the representation.

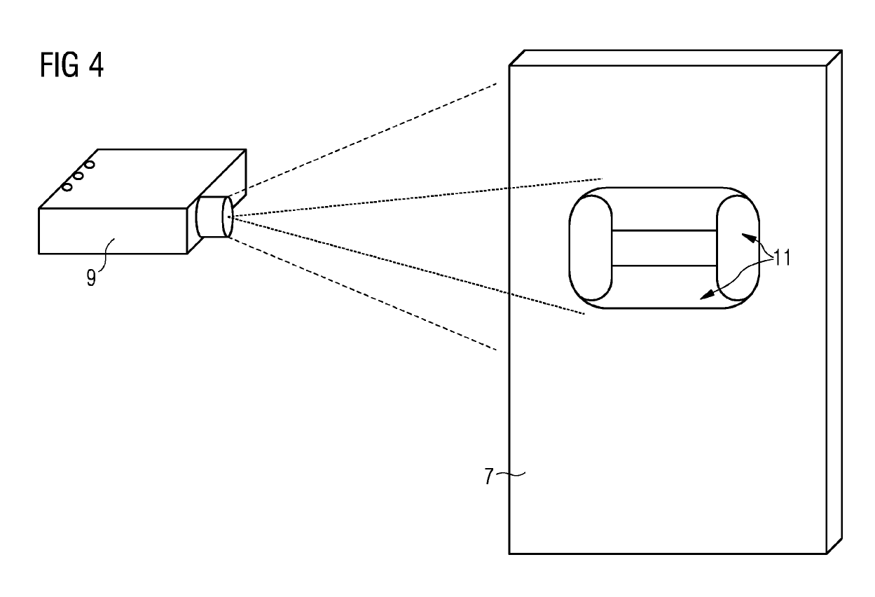

FIG. 4 shows a fourth exemplary embodiment of an indication 11 according to the invention. In this case, the illustration in accordance with FIG. 4 corresponds to FIG. 3, but with the difference that, depending on setting, color-coded areas are projected onto the region under examination after the measurement. The orientation of defects, and the region in which the latter are detectable can likewise be inferred with the aid of such a representation in accordance with FIG. 4.

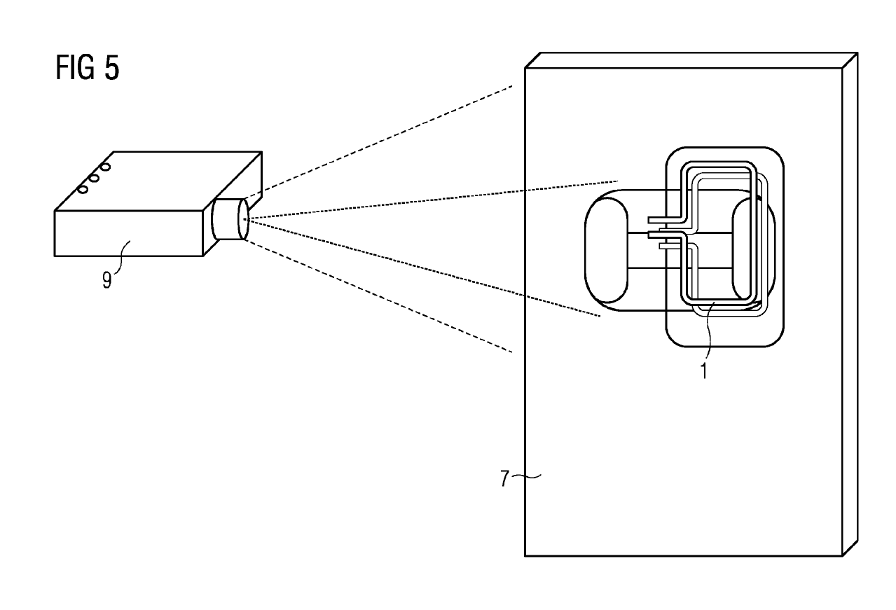

FIG. 5 shows how the testing technician moves the inductor 1 within the region of uniform geometry, and the projection is moved at the same time. It is possible in this way to make a good estimate as to which region of the test specimen 7 is being examined. In accordance with FIG. 5, the inductor 1 is rotated by 90 degrees by the testing technician using an activated positioning aid and is positioned in such a way that the green area of the positioning aid overlaps in part with the results of the first measurement. It can thus be ensured that the defect detection probability increases at the overlap regions, since defects can be visualized independently of their orientation.

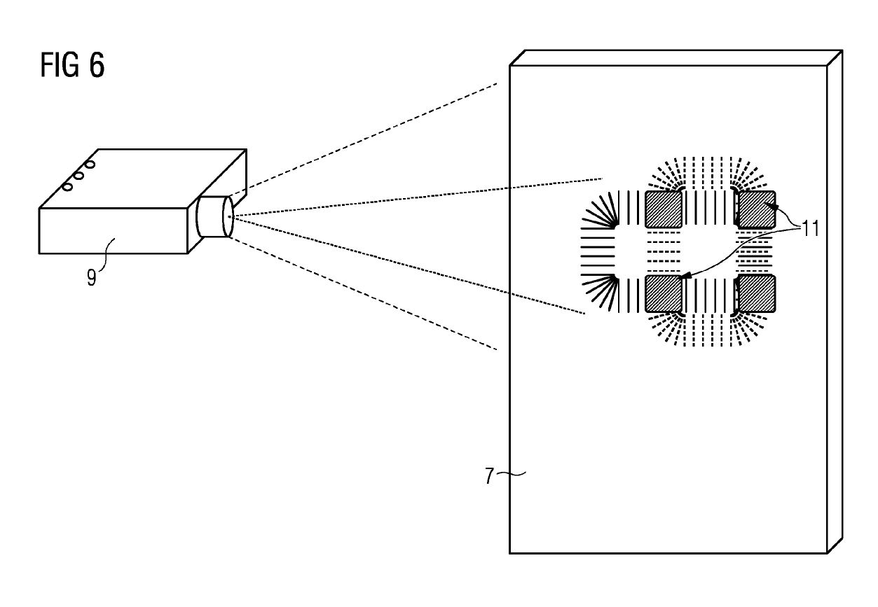

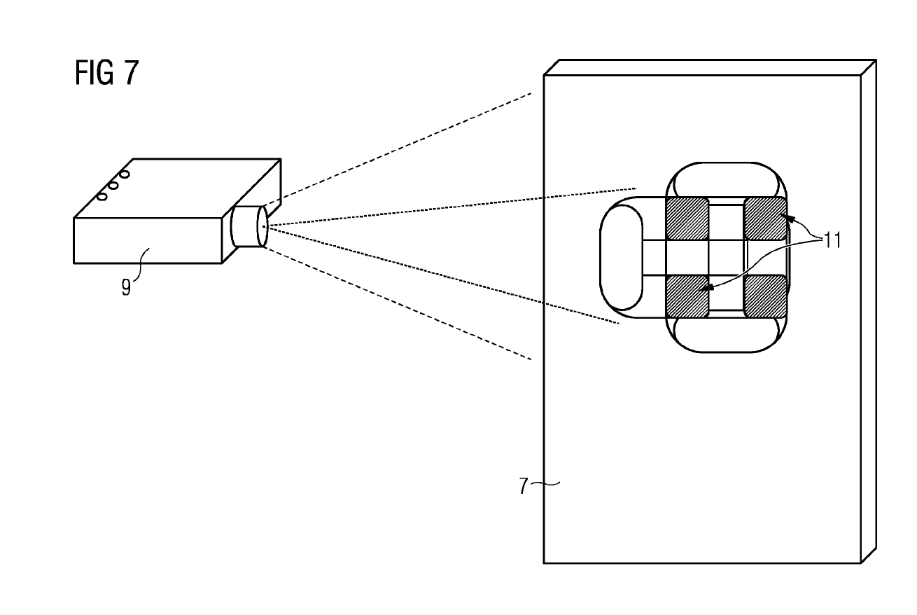

FIGS. 6 and 7 show further exemplary embodiments of indications 11 according to the invention for the case of a measurement and a further measurement following therefrom. Overlap regions of the two measurements are marked green in the projection, specifically both in the line setting and in the area setting. Further regions of the test object can be selected and tested subsequently. Moreover, in order to enable a consistent series testing of test specimens 7, information relating to the quality of the positioning of the inductor 1, or a quality of the relative positioning can be projected for the testing technician. By way of example, it is possible in this way for the testing technician to move the inductor 1 until a uniform stored optimum position is reached. It is ensured in this way that the inductor 1 is positioned at an identical relative position for each test specimen 7 of the series.

Information is represented cumulatively for all further measurements. If the testing technician changes the orientation of the inductor 1 for further measurements, for example by 90 degrees, the lines are projected for all measurements. They give an indication as to which crack directions of measurements already carried out have been covered by the assumed defect detection probability. Alternatively or cumulatively, new regions of the test specimen 7 can be covered by the inductor 1 for further measurements. Information and indications 11 can, for example, be projected onto the object as numbers, letters, colored fields, lines or any desired symbols.

The invention proposes a method and a device for scanning induction thermography for nondestructive material examination of a test specimen 7 which can be used by a testing technician to effectively improve the quality of a manual measurement. In order to achieve this, the testing technician is provided with an evaluation of recorded infrared images and the projection onto the test specimen 7 of indications 11 corresponding to the evaluation.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-34. (canceled)

35. A method for scanning induction thermography for non-destructive material examination of a test specimen by an infrared camera and an inductor positioned relative to the test specimen by a testing technician in a manual measurement during which an electric induction current is generated in the test specimen and infrared images of the test specimen are recorded, comprising:
evaluating, by a computer device, at least one of the infrared images; and
projecting by a projector device onto a surface of the test specimen, at least one indication, visible by the testing technician, corresponding to a result of said evaluating.

36. The method as claimed in claim 35, wherein the at least one indication includes a measurement indication projected at least one of during and after the manual measurement indicating whether the manual measurement is correctly carried out in respect of a required defect detection probability, taking account of measurement parameters.

37. The method as claimed in claim 36, further comprising determining by the computer device the defect detection probability of the manual measurement based on defect detection probability curves depending on a magnitude of a material defect while taking account of the measurement parameters.

38. The method as claimed in claim 36, wherein said evaluating of the at least one of the infrared images includes calculating the measurement parameters of the manual measurement.

39. The method as claimed in claim 38, wherein said evaluating of the at least one of the infrared images of the test specimen is carried out without an inductor to calculate measurement parameters.

40. The method as claimed in claim 38, wherein said calculating of the measurement parameters includes evaluation of an early infrared image, recorded before the induction of the induction current, of the inductor and of the test specimen.

41. The method as claimed in claim 38, wherein said calculating of the measurement parameters includes evaluation of an amplitude image generated by pulse-phase analysis of the infrared images recorded during the manual measurement.

42. The method as claimed in claim 38, wherein said calculating of the measurement parameters includes evaluation of a phase image generated by pulse-phase analysis of the infrared images recorded during the manual measurement.

43. The method as claimed in claim 36, wherein at least one measurement parameter is at least one of a distance between the inductor and the test specimen, a measurement range of the inductor, and orientation of the inductor with respect to the test specimen.

44. The method as claimed in claim 43, wherein said projecting projects lines running perpendicular to the orientation of the inductor onto the test specimen at least one of during and after the manual measurement to indicate that material defects extending along the lines have been acquired with a maximum defect detection probability.

45. The method as claimed in claim 44, further comprising:
changing the orientation of the inductor after the manual measurement to a changed orientation;
performing a further measurement; and
projecting onto the test specimen at least one of further lines running perpendicular to the changed orientation of the inductor and color-coded areas.

46. The method as claimed in claim 43, wherein said projecting projects color-coded areas onto the test specimen at least one of during and after the manual measurement to indicate that material defects extending in specific directions in respective colored areas have been acquired with a maximum defect detection probability.

47. The method as claimed in claim 36, wherein said projecting projects a setting indication at least one of during and after the manual measurement indicating whether the measurement parameters of the manual measurement are correctly set, when a geometry of the inductor, a position of the inductor with respect to the test specimen, and all the measurement parameters are known.

48. The method as claimed in claim 47, wherein said projecting projects a range indication indicating the measurement range of the inductor as a colored area on the test specimen as a function of the position of the inductor relative to the test specimen.

49. The method as claimed in claim 48, wherein said projecting projects identical measurement ranges of measurements with different orientations of the inductor in an overlapping fashion.

50. The method as claimed in claim 47, wherein said projecting projects a distance indication indicating correctness of the distance between inductor and test specimen at least one of during and after the manual measurement by a specific color of the colored area.

51. The method as claimed in claim 36, wherein said projecting projects an indication indicating an information item relating to quality of positioning of the inductor.

52. A device for scanning induction thermography for non-destructive material examination of a test specimen based on infrared images recorded by an infrared camera when an electric induction current is generated in the test specimen while an inductor is positioned relative to the test specimen by a testing technician during a manual measurement, comprising:
a computer device evaluating at least one of the infrared images; and
a projector device projecting onto a surface of the test specimen at least one indication, visible by the testing technician, corresponding to a result of the evaluation.

53. The device as claimed in claim 52, wherein the at least one indication includes a measurement indication projected at least one of during and after the manual measurement indicating whether the manual measurement is correctly carried out in respect of a required defect detection probability, taking account of measurement parameters.

54. The device as claimed in claim 53, wherein the computer device determines the defect detection probability of the manual measurement based on defect detection probability curves depending on a magnitude of a material defect while taking account of the measurement parameters.

55. The device as claimed in claim 53, wherein the computer device evaluates at least one of the recorded infrared images to calculate the measurement parameters of the manual measurement.

56. The device as claimed in claim 55, wherein the computer device evaluates the at least one of the infrared images of the test specimen without an inductor to calculate the measurement parameters.

57. The device as claimed in claim 55, wherein the computer device evaluates an early infrared image, recorded before the induction of the induction current, of the inductor and of the test specimen to calculate measurement parameters.

58. The device as claimed in claim 55, wherein the computer device evaluates an amplitude image generated by pulse-phase analysis of the infrared images recorded during the manual measurement to calculate the measurement parameters.

59. The device as claimed in claim 55, wherein computer device evaluates a phase image generated by pulse-phase analysis of the infrared images recorded during the manual measurement to calculate the measurement parameters.

60. The device as claimed in claim 53, wherein at least one measurement parameter is at least one of a distance between the inductor and the test specimen, a measurement range of the inductor, and orientation of the inductor with respect to the test specimen.

61. The device as claimed in claim 60, wherein said projector projects lines running perpendicular to the orientation of the inductor onto the test specimen at least one of during and after the manual measurement to indicate that material defects extending along the lines have been acquired with a maximum defect detection probability.

62. The device as claimed in claim 61,
wherein the orientation of the inductor is changed to a changed orientation after the manual measurement and a further measurement is carried out, and
wherein said projector projects onto the test specimen at least one of further lines running perpendicular to the changed orientation of the inductor and color-coded areas.

63. The device as claimed in claim 60, wherein said projector projects color-coded areas onto the test specimen at least one of during and after the manual measurement to indicate that material defects extending in specific directions in respective colored areas have been acquired with a maximum defect detection probability.

64. The device as claimed in claim 52, wherein said projecting projects a setting indication at least one of during and after the manual measurement indicating whether the measurement parameters of the manual measurement are correctly set, when a geometry of the inductor, a position of the inductor with respect to the test specimen, and all the measurement parameters are known.

65. The device as claimed in claim 64, wherein said projector projects a range indication indicating the measurement range of the inductor as a colored area on the test specimen as a function of the position of the inductor relative to the test specimen.

66. The device as claimed in claim 65, wherein said projector projects identical measurement ranges of measurements with different orientations of the inductor in an overlapping fashion.

67. The device as claimed in claim 64, wherein said projector projects a distance indication indicating correctness of the distance between inductor and test specimen at least one of during and after the manual measurement by a specific color of the colored area.

68. The device as claimed in claim 52, wherein said projecting projects an indication indicating an information item relating to quality of positioning of the inductor.
